(19) United States
(12) Patent Application Publication
(10) Pub. No.: US 2004/0000336 A1
(43) Pub. Date: Jan. 1, 2004

(54) One-way degassing valve for containers of powder products such as coffee and the like

(75) Inventor: Luigi Goglio, Milano (IT)

Correspondence Address: SUGHRUE MION, PLLC, 2100 PENNSYLVANIA AVENUE, N.W., WASHINGTON, DC, 20037, US

(73) Assignee: P.L.V. SPA

(21) Appl. No.: 10/446,668

(22) Filed: May 29, 2003

(30) Foreign Application Priority Data
Mar. 27, 2002 (IT) MI2002A 000636

(51) Int. Cl. F16K 13/10; F16K 15/14

(52) U.S. Cl. 137/247.15

(57) ABSTRACT

A one-way degassing valve for containers (1) made of cardboard or comprising at least one wall (2) or portion of wall of cardboard (6), wherein a hollow or depression (21) forming an inner protrusion (22), beneath which is disposed an impermeable diaphragm (23) held in position by an aluminium film (8) having at least one hole (26) coinciding with the area of said diaphragm (23) and bonded to said layer of cardboard (6) in an area outside the area of said diaphragm (23), such as to leave at least one track of non-bonding (25), communicating with a cut (10), made in said layer of cardboard (6), so as to allow communication between the inside and the outset of the container (1), through said at least one hole (26) in the aluminium sheet (8), the area of non-bonding around the diaphragm (23), said at least one track of non-bonding (25) and said cut (10).

### DESCRIPTION

The present invention refers to a one-way degassing valve for cardboard containers, or containers having at least one cardboard wall, for powder products such as coffee and the like.

The term cardboard in the present description must be understood in its broadest sense, in that it can consist of a multilayer material, comprising one layer of cardboard, able to give a certain stiffness to the structure, and possibly other layers of sheet material.

In the present description specific reference will be made to containers for coffee, but it is obvious that the invention extends to containers for any other product which, after packaging, develops gas.

One-way degassing valves, which are normally applied to the top wall of a container, serve to allow the gases developed by the product to leave the container, avoiding the formation of internal overpressures, which would cause bulging and/or bursting of the container, and at the same time to prevent the entry of air into the container, which would prejudice the quality of the product.

Said valves open when overpressures occur inside the container and close again when said overpressures cease.

They normally comprise porous filters which retain the particles of coffee allowing the gas to pass through, and an impermeable diaphragm enclosed in a shell of rigid plastic, formed in at least two parts, a base and a cover.

The above valves are suitable in particular for containers in flexible material, to which they are welded, sealed or bonded.

In any case they present the drawback of relatively high production costs and complexity of manufacturing and assembly, as well as difficulty in mounting them on the container.

The object of the invention is to eliminate the above drawbacks, in particular of to provide a one-way degassing valve for cardboard containers that is simple and cheap to make and has a minimal impact on the cost of the container.

Another object of the invention is to provide such a valve that does not involve substantial additions of parts to the container, but that can be made substantially with the same material as the container, without causing an appreciable increase in the thickness of the wall thereof.

Yet another object of the invention is to provide such a valve that is reliable in operation.

These objects are achieved by the one-way degassing valve according to the invention, which has the characteristics listed in appended independent claim 1.

Advantageous embodiments of the invention are apparent from the dependent claims.

Substantially, the valve according to the invention is formed directly on a cardboard wall of the container, normally the top wall, wherein an inner protrusion is formed, preferably annular in shape, coinciding with which a sealing diaphragm of impermeable material, held in place by an inner aluminium film bonded to the cardboard, is disposed.

Welding or bonding of the aluminium film to the cardboard involves such a surface as to leave free a central area wherein said sealing diaphragm is disposed and at least one track which, starting from said central area, reaches at least to a cut made in the cardboard wall.

In the aluminium film, in the area in which it covers the sealing diaphragm, and preferably in the centre thereof, there is provided a hole, which can be put into communication with the outside through the space which is created between the aluminium film and the impermeable diaphragm, a channel which is formed coinciding with said at least one track of non-bonding and said cut made in the cardboard.

Between the sealing diaphragm and the aluminium film there is disposed a viscous or lubricating substance, in particular a silicone oil, which involves at least one perimeter extending around said hole in the aluminium film.

In this manner, the thin diaphragm, which is kept in a state of elastic pretension because of the inside deformation of the cardboard, moistened with silicone oil, adheres to the aluminium film and prevents the entry of air into the container in the event of outside overpressure.

On the contrary, in the event of overpressure inside the container, the gas generated by the product enters the central hole in the aluminium film, passes through the space between the diaphragm and the film pushing the silicone oil and exits to the outside through said at least one channel and said cut in the cardboard.

The degassing valve according to the invention finds an advantageous application in the cardboard container forming the subject matter of Italian patent application No. MI2001A 002635 of 31 Dec. 2001, in the name of the same applicant, PLV S.p.A. In an embodiment described in this Italian patent application, the top closure wall of the container has a closed cut line, to facilitate removal of a disk and form an opening for access to the product. A thin aluminium film, which forms a seal and is torn along said cut line of the cardboard during removal of the disk, is applied to the inside of said wall.

In such an embodiment, the degassing valve according to the invention can easily be provided inside said disk.

Further characteristics of the invention will be made clearer by the detailed description that follows, referring to a purely exemplary and therefore non limiting embodiment thereof, illustrated in the appended drawings, in which:

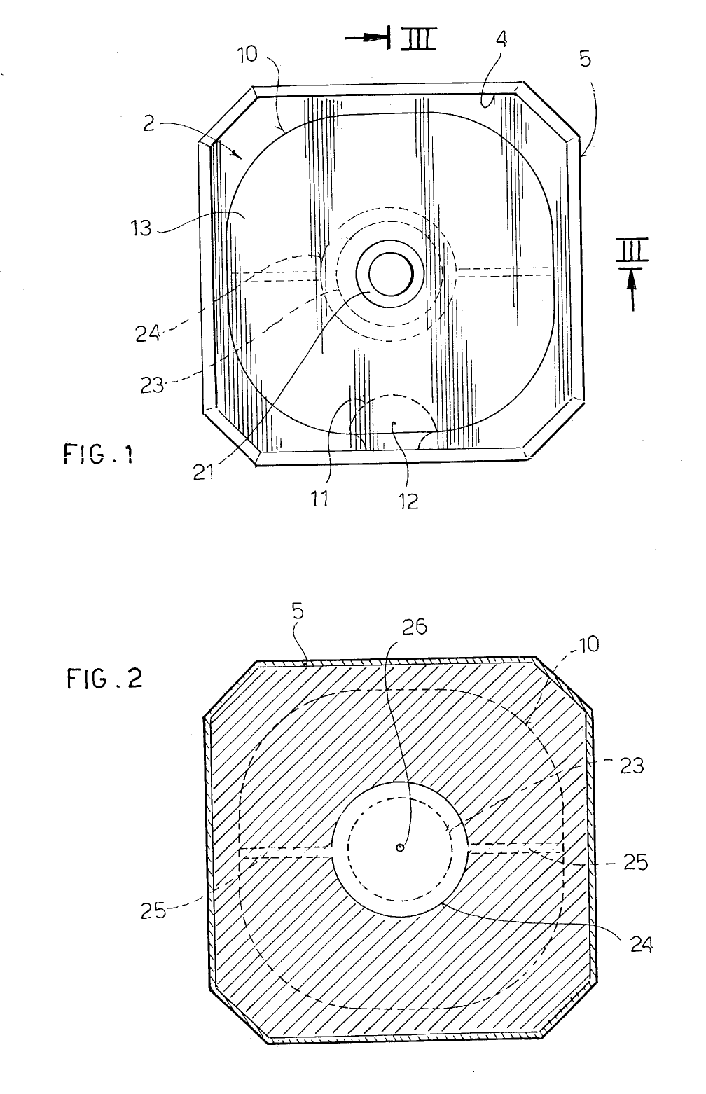

FIG. 1 is a top plan view of a cardboard container to which a degassing valve according to the invention is applied;

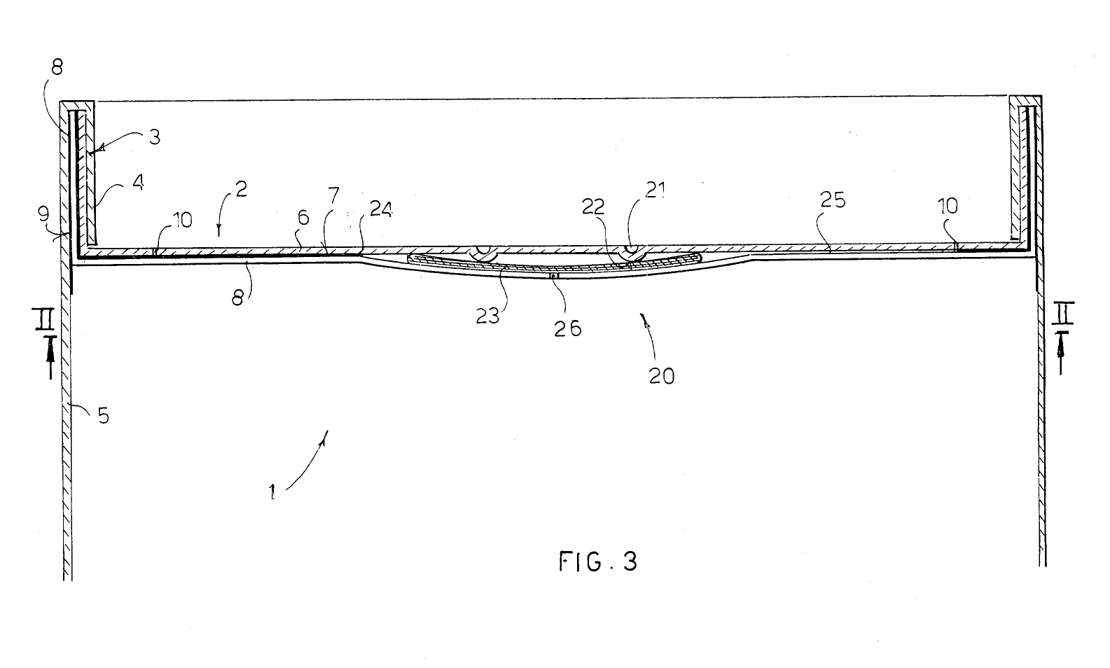

FIG. 2 is a view taken along the plane of section II-II of FIG. 3, showing the rear surface of what can be seen in FIG. 1;

FIG. 3 is an enlarged section taken along the planes III-III of FIG. 1;

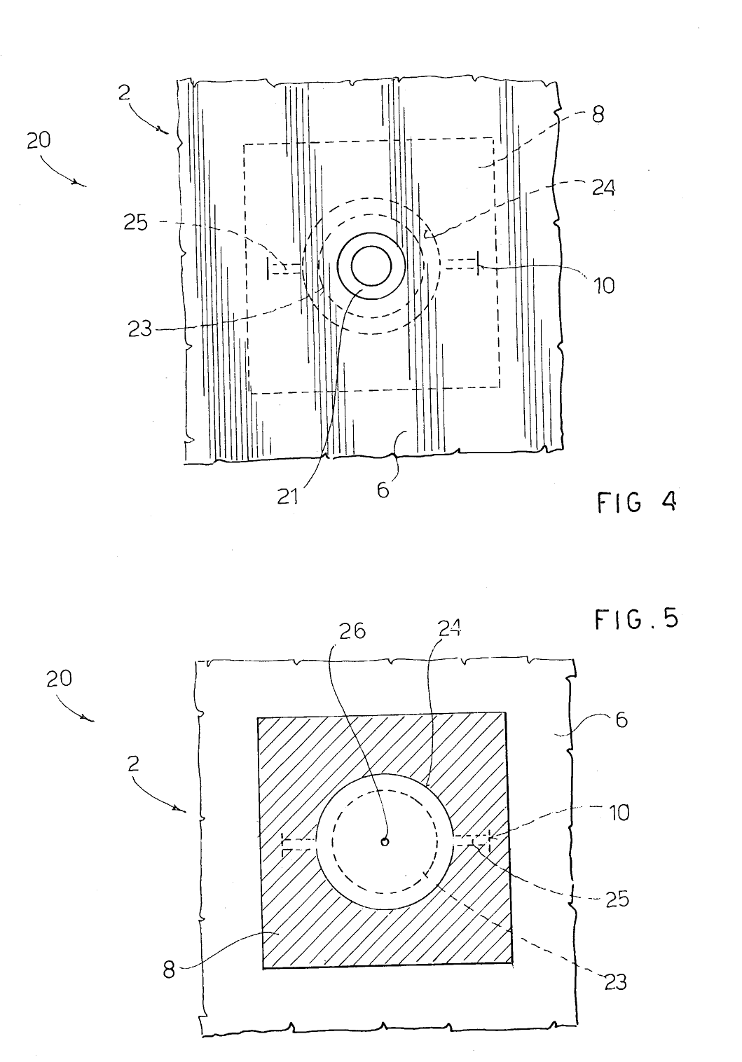

FIGS. 4 and 5 are plan views, from the outside and the inside, respectively, substantially like FIGS. 1 and 2, respectively, of a portion of cardboard wall of a container to which a degassing valve according to the invention is applied.

With reference to said figures, and for now in particular to FIGS. 1 and 3, reference numeral 1 denotes generally a cardboard container for containing products, for example, granular or powder products, such as coffee and the like, of the type described in the aforementioned Italian patent application No. MI2001A 002635.

Said container, only the top part of which has been shown schematically (FIG. 3) has a top closure wall 2 octagonal in plan view (FIGS. 1 e 2).

In particular the top wall 2 has a peripheral edge 3 folded upwards at 90° around which an upper peripheral edge 4 of the side wall 5 of the container 1 is folded inward.

Said top wall 2 comprises an outer layer of cardboard 6, an intermediate layer of heat-bondable or heat-sealable material, such as polyethylene 7 and an inner film of aluminium 8, bonded to the cardboard layer 6.

A layer of polyethylene 9 is also applied to the inside of the side wall 5 of the container, at least in its top part, to allow bonding with the aluminium layer 8 of the folded edge 3 of the top wall 2. A cut line 10 is provided in the cardboard layer 6 of the wall 2. The cut line 10 is closed and it extends substantially parallel to the octagonal perimeter of the wall 2, following a preferably rounded path and having a crescent-shaped recess 11, so that on pressing on the portion 12 in front of the crescent 11 an opening is formed through which a central disk or tongue 13 of the top wall 2 can be gripped to remove it along the cut line 10, causing opening of the container. During said removal, the aluminium film 8 which adheres closely to the inner surface of the wall 2 is cut perfectly along said cut line 10 of the cardboard layer 6.

The degassing valve according to the invention, designated as a whole with reference numeral 20, is applied, without substantial modifications, to said container. In particular, the valve 20 is formed in said top wall 2 of the container, the cardboard layer of which has a central deformation such as to determine an annular depression 21 on the outside, to which corresponds an annular protrusion 22 on the inside.

Beneath said annular protrusion 22 there is disposed a discoid sealing diaphragm 23, with a larger diameter than that of the annular protrusion 22, said diaphragm 23 being pushed against the annular protrusion 22, and thus maintained in a state of elastic pretension, by the internal aluminium film, which obviously is not bonded to the cardboard layer 6, in the area of the diaphragm 23.

The hatching in FIG. 2 indicates the areas of bonding of the aluminium film 8 to the cardboard layer 6, and as can be seen, the bonding is interrupted at a central circumference 24 outside the diaphragm 23.

Furthermore, the bonding is interrupted at two diametrically opposite tracks 25, which reach from said central circumference 24 at least to said cut line 10 in the cardboard layer 2.

Centrally to the aluminium film 8 there is provided a hole 26 (FIGS. 2 and 3), which can communicate with the outside through the channels that are formed between the aluminium film 8 and the cardboard layer 6 at said tracks of non-bonding 25, and said cut line 10, into which said channels open.

The surface of the sealing diaphragm 23 facing towards the aluminium film 8 is at least partially moistened with a viscous or lubricating substance, preferably silicone oil, so as to adhere to the aluminium film.

In this manner, the diaphragm 23, being viscously attached to the aluminium film 8, also thanks to a state of pretension, remains adherent thereto, so that in the case of external overpressure, air cannot enter into the container through the cut line 6 and said channels 25, since it encounters a barrier at the diaphragm which adheres to the aluminium film.

On the contrary, in the case of overpressure inside the container, which can occur due to the gases released by the product, said gases, passing through the hole 26 of the aluminium film tend to lift the diaphragm 23 slightly, and by pushing the silicone oil interposed between the diaphragm and the aluminium film make their way towards the outside passing through the channels 25 and the cut line 10 in the cardboard layer 6 of the container wall 2.

The one-way nature of the valve is thus guaranteed.

Said internal annular protrusion 22 is obtained by means of embossing which deforms the cardboard layer, for example by about 0.4 mm, a sufficient amount to hold the diaphragm 23 against the substantially rigid aluminium film 8, and prevent the entry of air.

The diaphragm 23 is made of an impermeable elastic material, for example a polyester-aluminium-polyethylene multi-layer.

In the example described two connecting channels 25 have been shown between the central hole 26 for entry of gas and the cut line 10 in the cardboard, but it is obvious that only one channel could be provided, or possibly more than two channels.

The internal protrusion 22 and the diaphragm 23 have been shown circular in shape, in that this is the most appropriate geometrical form, because it is regular along the entire perimeter, but it is obvious that other geometrical forms are possible.

FIGS. 4 and 5 show a valve 20 according to the invention applied to a wall 2, illustrated only partially, and comprising a layer of cardboard 6.

In FIGS. 4 and 5 the same reference numerals introduced in relation to FIGS. 1 and 3 have been used, to distinguish like or corresponding elements.

The solution is exactly the same as that of FIGS. 1 to 3, except that the aluminium film 8 is applied in this case only to the area strictly necessary for formation of the valve 20, that is, to cover the diaphragm 23 and the cut line 10 formed in the layer of cardboard 6, which in this case can be formed by simple small cuts into which the channels 25 open.

Operation of the valve is exactly the same as that illustrated with reference to FIGS. 1 to 3.

Naturally the invention is not limited to the particular embodiment described previously and illustrated in the appended claims, but numerous modifications of detail within the reach of a person skilled in the art can be made thereto, without thereby departing from the scope of said invention, as set forth in the claims that follow.

1. A one-way degassing valve for containers (1) of cardboard or comprising at least one cardboard wall (2) or portion of wall (6), characterised in that in said portion or layer of cardboard (6) there is provided a hollow or depression (21), forming an inner protrusion (22), beneath which is disposed an impermeable diaphragm (23) held in position by an aluminium film (8), having at least one hole (26) corresponding with the area of said diaphragm (23), and bonded or welded or sealed to said layer of cardboard (6) in an area outside the area of said diaphragm (23), so as to leave at least one track of non bonding (25), communicating with a cut (10), formed in said layer of cardboard (6) so as to allow communication between the inside and the outside of the container (1), through said at least one hole (26) in the aluminium sheet (8), the area of non welding around the diaphragm (23), said at least one track of non bonding (25) and said cut (10).

2. A degassing valve according to claim 1, characterised in that between said diaphragm (23) and said aluminium film (8) there is interposed a viscous or lubricating substance, at least in the area surrounding said at least one hole (26) in the aluminium sheet.

3. A degassing valve according to claim 2, characterised in that said viscous substance is silicone oil.

4. A degassing valve according to any one of the preceding claims, characterised in that said inner protrusion (22) is a continuous annular protrusion, and said diaphragm (23) is discoid in shape with a greater diameter than that of said protrusion (22).

5. A degassing valve according to any one of the preceding claims, characterised in that said aluminium sheet (8) is bonded to said cardboard layer (6) by interposition of a layer of heat-bondable or heat-sealable material (7).

6. A degassing valve according to any one of the preceding claims, characterised in that the area of bonding of said aluminium film (8) to said layer of cardboard (6) is delimited on the inside by a continuous, closed peripheral line (24), interrupted only by said at least one track of non-bonding (25).

7. A degassing valve according to any one of the preceding claims, characterised in that said cut line (10) is a closed continuous or discontinuous line which surrounds the peripheral line (24) delimiting on the inside the area of bonding of the film (8).

8. A degassing valve according to any one of claims 1 to 6, characterised in that said cut line (10) comprises discrete cuts in the cardboard layer (6) coinciding with each of said tracks of non-bonding (25).

9. A degassing valve according to any one of the preceding claims, characterised in that it is applied to any container by means of adhesive, so as to give rise to at least one transverse channel (25) for release of the excess pressure from the inside to the outside of the container.

10. A degassing valve according to any one of the preceding claims, characterised in that said layer of cardboard (6) forms part of the top wall (2) of the container (1), said aluminium film extending to cover entirely said cardboard layer (6) of the wall (2), said cut line (10) extending along an outline substantially parallel to the peripheral edge of the container (1), such that breakage of said wall (2) along said cut line (10) causes removal of said central disc (13), to which said valve (20) remains attached, forming an opening for access to the product of the container (1).

11. A container (1) made of cardboard, comprising a one-way degassing valve according to any one of the preceding claims.

12. A container according to claim 11, characterised in that said container comprises a side wall (5) the upper edge (4) of which is folded inside an upturned peripheral edge (3) of a top wall (2) comprising an outer layer of cardboard (6) and an inner aluminium film (8) bonded to the layer of cardboard (6) by means of interposition of a layer of heat-bondable polyethylene (7), said degassing valve (20) being disposed in the central area of said wall (2) and said cut line (10) extending substantially parallel to the side edge of the container (1).
